(19) United States
(12) Patent Application Publication
(10) Pub. No.: US 2012/0262912 A1
(43) Pub. Date: Oct. 18, 2012

(54) UV FLUORESCENT TUBE GENERATING BLACK LIGHT

(76) Inventor: Shiu Kei WONG, Kwun Tong (HK)

(21) Appl. No.: 13/443,019

(22) Filed: Apr. 10, 2012

(30) Foreign Application Priority Data
Apr. 14, 2011 (DE) 20 2011 000 880.0

(51) Int. Cl. F21V 21/00

(52) U.S. Cl. 362/217.1

(57) ABSTRACT

UV fluorescent tube generating black light, comprising an elongate tubular glass body having electrical connection means on its ends, the UV fluorescent tube being formed as a UV fluorescent tube generating bluish-white light, characterized in that the UV fluorescent tube comprises a translucent, in particular transparent, plastic covering arranged around the glass body of the UV fluorescent tube, the plastic covering being provided with colorant particles which on the one hand transmit the black-light UV light components to at least 50%, in particular at least 75% or even fully, and on the other hand block the visible light components which are not black-light UV light components to at least 50%, in particular at least 75% or even 90% or even fully, the glass body of the UV fluorescent tube and the colorant particles of the plastic covering, and the plastic covering itself, respectively containing no lead.

### CROSS-REFERENCE TO RELATED APPLICATIONS AND CLAIM TO PRIORITY

This application is related to patent application No. 20 2011 000 880.0, filed Apr. 14, 2011, in the Federal Republic of Germany, the disclosure of which is incorporated by reference and to which priority is claimed.

### FIELD OF THE INVENTION

The invention relates to a UV fluorescent tube generating black light, comprising an elongate tubular glass body having electrical connection means on its ends.

### BACKGROUND OF THE INVENTION

Such UV fluorescent tubes generating black light, in which the glass body is provided with a lead-containing filter layer which transmits only the black-light components, are known in practice.

A disadvantage with this is that lead, as a toxic heavy metal, is environmentally unfriendly and problematic to dispose of.

### SUMMARY OF THE INVENTION

It is an object of the invention to avoid the aforementioned disadvantages and provide a way of obtaining a black-light effect by means of a UV fluorescent tube without using lead.

This object is achieved in that the UV fluorescent tube comprises a translucent, in particular transparent, plastic covering arranged around the glass body of the UV fluorescent tube, the plastic covering being provided with colorant particles which on the one hand transmit the black-light UV light components to at least 50%, in particular at least 75% or even fully, and on the other hand block the visible light components which are not black-light UV light components to at least 50%, in particular at least 75% or even 90% or even fully, the glass body of the UV fluorescent tube and the colorant particles of the plastic covering, and the plastic covering itself, respectively containing no lead.

Negative impacts on the environment due to the use of lead are therefore avoided.

At the same time, substantial components of the visible light are not visible, unless they are black-light UV light components, whereas the black-light UV light components are to a large part emitted and can therefore exert their optical action by means of the black-light effect.

The plastic covering may preferably be formed as a film, in particular a self-adhesive film, so that simple application of the plastic covering onto the UV fluorescent tube by winding or adhesive bonding is possible with little material outlay.

The plastic covering may also be formed as a plastic tube enclosing the UV fluorescent tube, so that particularly simple application is possible by sliding along the lengthwise extent of the UV fluorescent tube, or else in the case of a plastic tube formed with a slit by clipping on.

Advantageously, at least some colorant particles may be embedded in the material of the plastic covering, and in particular these may have already been introduced into the plastic covering during its manufacture, so that simple and economical production is possible.

According to the invention, the material of the plastic covering may be polymethyl methacrylate (PMMA).

In a preferred exemplary embodiment of the invention, the UV fluorescent tube may be integrated into a light stick. A light stick is intended to mean a light which comprises the light source per se in the form of the UV fluorescent tube, the plastic covering formed as a plastic tube enclosing the UV fluorescent tube, and the necessary electrical connection means, these components being formed together as a unit which cannot be separated without damage.

### BRIEF DESCRIPTION OF THE DRAWINGS

An exemplary embodiment of the invention, represented in the drawing, will be explained below.

FIG. 1 shows an exploded diagram of an object according to the invention and

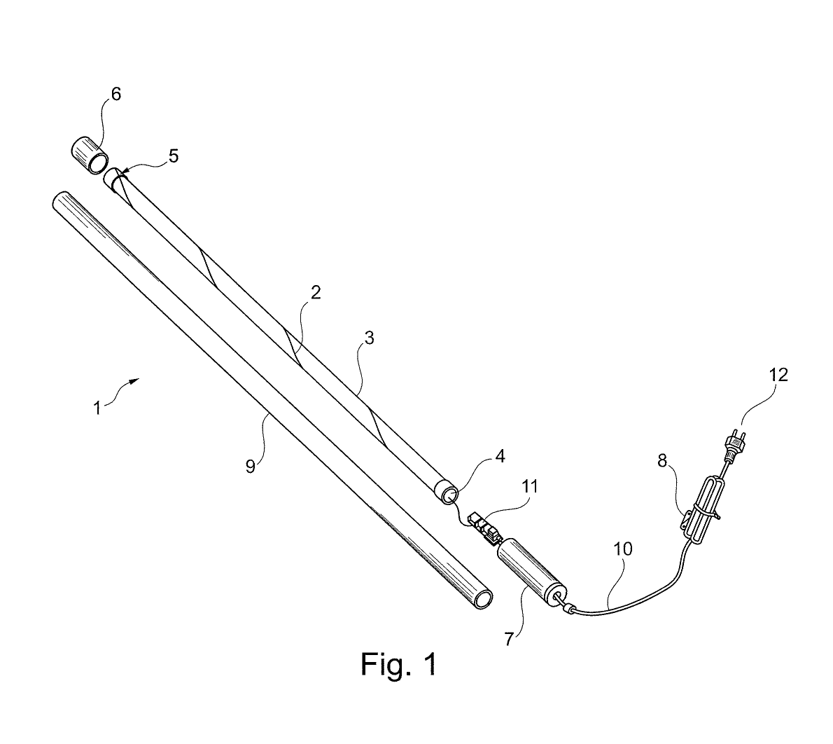

FIG. 2 shows a perspective view of the object according to FIG. 1 in the assembled state.

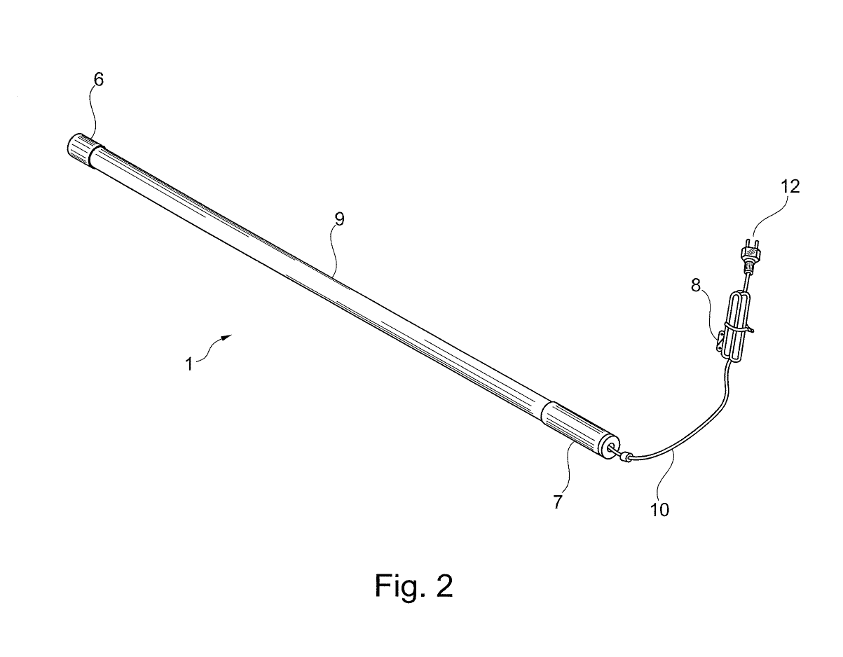

### DETAILED DESCRIPTION OF THE PREFERRED EMBODIMENT(S)

The two figures show a light, colloquially referred to as a “light stick” 1, which comprises a UV fluorescent tube and a plastic covering 9, formed as a plastic tube and enclosing the UV fluorescent tube 3.

The UV fluorescent tube 3 comprises an elongate tubular glass body, which has electrical connection means 4 on its ends. Connected to one of the connection means 4 there are ballast electronics 11, which are connected by an electrical lead 2 wound around the glass body of the UV fluorescent tube 3 to the other connection means 5 provided at the other end of the UV fluorescent tube 3.

Arranged around the glass body of the UV fluorescent tube 3, there is a plastic covering 9 which is provided with colorant particles that on the one hand transmit the black-light UV light components to at least 50%, in particular at least 75% or even fully, and on the other hand block the visible light components which are not black-light UV light components to at least 50%, in particular at least 75% or even 90% or even fully. Neither the glass body of the UV fluorescent tube 3 nor the colorant particles of the plastic covering 9, or the plastic covering 9 itself, contains lead.

The light stick 1 furthermore comprises end caps 6, 7, which enclose the end regions of the UV fluorescent tube 3 and of the plastic covering 9, and which therefore make the connection means 4, 5 inaccessible. The ballast electronics 11 are also arranged in the end cap 7 to which ballast electronics an electrical connection lead 10 for the electricity mains is connected, this lead comprising an on/off switch 8 as well as a mains plug 12. The aforementioned components are formed as a unit which cannot be separated without damage.

It will be apparent to one of ordinary skill in the art that various modifications and variations can be made in construction or configuration of the present invention without departing from the scope or spirit of the invention. Thus, it is intended that the present invention cover all such modifications and variations, and as may be applied to the central features set forth above.

I claim:

1. UV fluorescent tube (3) generating black light, comprising an elongate tubular glass body having electrical connection means (4, 5) on its ends, the UV fluorescent tube (3) being formed as a UV fluorescent tube (3) generating bluish-white light, characterized in that the UV fluorescent tube (3) comprises a translucent, in particular transparent, plastic covering (9) arranged around the glass body of the UV fluorescent tube (3), the plastic covering (9) being provided with colorant particles which on the one hand transmit the black-light UV light components to at least 50%, in particular at least 75% or even fully, and on the other hand block the visible light components which are not black-light UV light components to at least 50%, in particular at least 75% or even 90% or even fully, the glass body of the UV fluorescent tube (3) and the colorant particles of the plastic covering (9), and the plastic covering (9) itself, respectively containing no lead.

2. UV fluorescent tube (3) according to claim 1, characterized in that the plastic covering (9) is formed as a film, in particular a self-adhesive film.

3. UV fluorescent tube (3) according to claim 1, characterized in that the plastic covering (9) is formed as a plastic tube enclosing the UV fluorescent tube (3).

4. UV fluorescent tube (3) according to claim 1, characterized in that at least some colorant particles are embedded in the material of the plastic covering (9), and in particular have already been introduced into the plastic covering (9) during its manufacture.

5. UV fluorescent tube (3) according to claim 1, characterized in that the material of the plastic covering (9) is polymethyl methacrylate (PMMA).

6. UV fluorescent tube (3) according to claim 1, characterized in that the UV fluorescent tube (3) is integrated into a light stick.

7. UV fluorescent tube (3) according to claim 2, characterized in that at least some colorant particles are embedded in the material of the plastic covering (9), and in particular have already been introduced into the plastic covering (9) during its manufacture.

8. UV fluorescent tube (3) according to claim 3, characterized in that at least some colorant particles are embedded in the material of the plastic covering (9), and in particular have already been introduced into the plastic covering (9) during its manufacture.

9. UV fluorescent tube (3) according to claim 2, characterized in that the material of the plastic covering (9) is polymethyl methacrylate (PMMA).

10. UV fluorescent tube (3) according to claim 3, characterized in that the material of the plastic covering (9) is polymethyl methacrylate (PMMA).

11. UV fluorescent tube (3) according to claim 4, characterized in that the material of the plastic covering (9) is polymethyl methacrylate (PMMA).

12. UV fluorescent tube (3) according to claim 2, characterized in that the UV fluorescent tube (3) is integrated into a light stick.

13. UV fluorescent tube (3) according to claim 3, characterized in that the UV fluorescent tube (3) is integrated into a light stick.

14. UV fluorescent tube (3) according to claim 4, characterized in that the UV fluorescent tube (3) is integrated into a light stick.

15. UV fluorescent tube (3) according to claim 5, characterized in that the UV fluorescent tube (3) is integrated into a light stick.
